(19) United States
(12) Patent Application Publication
(10) Pub. No.: US 2019/0064418 A1
(43) Pub. Date: Feb. 28, 2019

(54) BACKLIGHT MODULE AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Yang CHU, Beijing (CN); Zhanchang BU, Beijing (CN); Ming CHEN, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/767,285

(22) PCT Filed: Sep. 11, 2017
(86) PCT No.: PCT/CN2017/101259

§ 371 Date: Apr. 10, 2018

(30) Foreign Application Priority Data
Feb. 9, 2017 (CN) CN201720121536.8

(51) Int. Cl. F21V 8/00

(52) U.S. Cl. CPC G02B 6/003; G02B 6/0055; G02B 6/0025

(57) ABSTRACT

The disclosure relates to a backlight module and a display device. A backlight module, comprises a light guide plate; a light source disposed adjacent to a light entering side of the light guide plate; and a light converging element disposed between the light guide plate and the light source, and configured such that light, from the light source, incident on a surface of the light guide plate opposite to a light-exiting surface of the light guide plate to satisfy a total reflection condition at the surface.

### CROSS-REFERENCES TO RELATED APPLICATIONS

This application claims priority and benefit of Chinese Patent Application No. 201720121536.8, filed on Feb. 9, 2017, the entire content of which is incorporated by reference herein.

### FIELD

Embodiments of the present disclosure relate to the field of display technologies, and in particular, to a backlight module and a display device.

### BACKGROUND

A liquid crystal display device is a main type of flat panel display device. Because of its small size, low power consumption, radiation-free, relatively low production costs and other characteristics, it has been increasingly used in the display areas with high-performance. For a liquid crystal display device, as liquid crystals themselves cannot emit light, it is necessary to provide a light-emitting unit such as a backlight module on the back side of the liquid crystal display panel to realize the display function of the liquid crystal display device. The backlight module functions as a surface light source for providing light with high luminance and uniformity for the display device, so that the display panel can display images normally.

### BRIEF SUMMARY

Provided in embodiments of the present disclosure are a backlight module and a display device.

In an aspect of the present disclosure, there is provided a backlight module comprising: a light guide plate; a light source disposed adjacent to a light entering side of the light guide plate; and a light converging element disposed between the light guide plate and the light source and configured such that light, from the light source, incident on a surface of the light guide plate opposite to a light-exiting surface of the light guide plate satisfies a total reflection condition at the surface.

In one or more embodiments, the light converging element is disposed on a surface of the light entering side of the light guide plate.

In one or more embodiments, the light converging element and the light guide plate are formed of the same material.

In one or more embodiments, the light converging element and the light guide plate comprise a glass material or a resin material.

In one or more embodiments, the light converging element comprises a light converging prism, a light converging lens, or a combination thereof.

In one or more embodiments, the light converging element comprises a hemispherical convex lens.

In one or more embodiments, a maximum radius r of the hemispherical convex lens is calculated according to the following equation:

d+r·(1·cos θ)=r·sin θ/tan(α/2)

Where, the light source is disposed on a symmetric axis of the hemispherical convex lens, and the hemispherical convex lens and the light guide plate have the same refractive index; d is a distance between the light source and a point on the hemispherical convex lens closest to the light source; θ is an angle between a normal of the hemispherical convex lens at an intersection of an edge light ray of the light emitted by the light source and a hemispherical surface of the hemispherical convex lens and the symmetric axis, and is calculated by the following equation:

n₂ sin(α/2+θ)=n₁ sin(90°·arcsin(n₃/n₁)+θ);

Where, n₁ is the refractive index of the light guide plate and the hemispherical convex lens; n₂ is a refractive index of ambient gas; n₃ is a refractive index of a medium in contact with a side of the light guide plate opposite to the light-exiting surface of the light guide plate; α is a light-emitting angle of the light source.

In one or more embodiments, the light converging element comprises an isosceles triangular prism.

In one or more embodiments, the isosceles triangular prism has a minimum base angle β calculated according to the following equation:

n₂ sin(α/2+β)=n₁ sin(90°·arcsin(n₃/n₁)+β)

Where, the light source is disposed on a symmetric axis of the isosceles triangular prism, and the isosceles triangular prism and the light guide plate have the same refractive index; n₁ is the refractive index of the light guide plate and the isosceles triangular prism; n₂ is a refractive index of ambient gas; n₃ is a refractive index of a medium in contact with a side of the light guide plate opposite to the light-exiting surface of the light guide plate; and α is a light-emitting angle of the light source.

In one or more embodiments, the light source comprises an LED having a light-emitting angle ranging from 110° to 120°.

In one or more embodiments, the refractive index of the light guide plate and the light converging element ranges from 1.45 to 1.60.

In one or more embodiments, the distance between the light source and the light converging element ranges from 0.1 mm to 0.3 mm.

In one or more embodiments, there is further comprised a reflective element disposed on a surface of the light guide plate opposite to the light-exiting surface of the light guide plate and an adhesive layer configured for adhering the reflective element to the light guide plate.

In one or more embodiments, the refractive index of the adhesive layer has a range of larger than 1 and less than or equal to 1.35.

In another aspect of the present disclosure, there is provided a display device, comprising a backlight module in any one of the embodiments described herein and a display panel.

Further adaptive aspects and scopes of the present disclosure become apparent from the description provided herein. It should be understood that various aspects of the present disclosure may be implemented separately or in combination with one or more other aspects. It should also be understood that the description in the present disclosure and objectives which are intended to be merely described in the specific embodiments are not intended to limit the scope of the present disclosure.

### BRIEF DESCRIPTION OF THE DRAWINGS

The accompanying drawings described herein are merely for the purpose of describing the selected embodiments and are not all possible implementations and are not intended to limit the scope of the present disclosure, wherein:

FIG. 1 is a schematic structural diagram of a backlight module;

FIG. 2 is a schematic structural diagram of a backlight module in an embodiment of the present disclosure;

FIG. 3 is a schematic representation of geometric parameters of various components of the backlight module in the case where the light converging element is a hemispherical convex lens in an embodiment of the present disclosure;

FIG. 4 is a schematic representation of geometric parameters of various components of the backlight module in the case where the light converging element is an isosceles triangular prism in an embodiment of the present disclosure; and

FIG. 5 is a schematic structural diagram of a display device in an embodiment of the present disclosure.

Corresponding reference numerals indicate corresponding parts or features throughout the several views of the drawings.

### DETAILED DESCRIPTION

Various embodiments will now be described in detail with reference to the drawings, which are provided as illustrative examples of the disclosure so as to enable those skilled in the art to practice the disclosure. Notably, the figures and the examples below are not meant to limit the scope of the present disclosure. Where certain elements of the present disclosure may be partially or fully implemented using known components, only those portions of such known components that are necessary for an understanding of the present disclosure will be described, and the detailed descriptions of other portions of such known components will be omitted so as not to obscure the disclosure. Further, various embodiments encompass present and future known equivalents to the components referred to herein by way of illustration.

In the description of the present disclosure, an orientational or positional relationship indicated by the terms “on”, “above”, “under”, “below”, “between” or the like is an orientational or positional relationship based on the drawings, merely for purposes of describing the present disclosure and simplifying the description, rather than indicating or implying that the device or element referred to must be particularly oriented or must be constructed and operated in a particular orientation, and should not be construed as limiting the present disclosure. Further, when an element or layer is referred to as being “on” another element or layer, it can be directly on the other element or layer, or there may be an intermediate element or layer; similarly, when an element or layer is referred to as being “under” another element or layer, it could be directly under the other element or layer, or there may be an intermediate element or layer; and when an element or layer is referred to as being “between” two elements or layers, it could be the unique element or layer between the two elements or layers, or there may be more than one intermediate element or layer.

The articles “a”, “an”, “the” and “said” are intended to mean that there is one or more elements when introducing elements and embodiments of the application, unless the context clearly indicates otherwise; the term “a plurality of” means two or more, unless stated otherwise; the terms “include”, “comprise”, “contain” and “have” are intended to be inclusive and mean that there may be additional elements in addition to the listed elements.

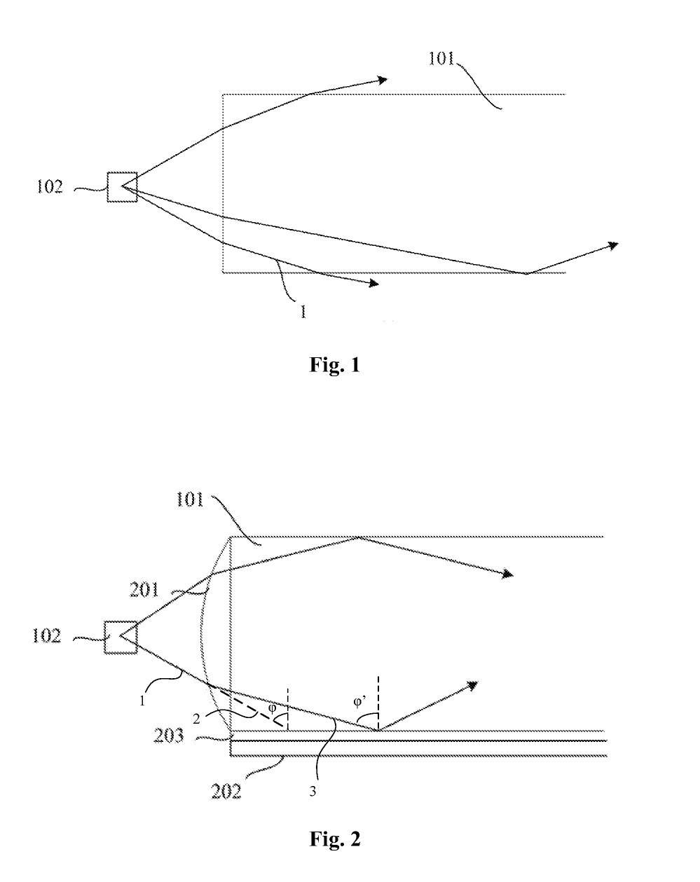

FIG. 1 is a schematic structural diagram of a backlight module. As shown in FIG. 1, the backlight module may comprise a light guide plate 101; and a light source 102 disposed adjacent to a light entering side of the light guide plate 101. At least a portion of light emitted by the light source may enter the light guide plate from the light entering side of the light guide plate and be guided by the light guide plate to respective light-exiting points of the light guide plate, so that light may exit from the light-exiting points of the light guide plate and may be utilized by the display panel positioned above the light guide plate.

In general, it is expected that light entering the light guide plate may uniformly exit from the light-exiting points on the light-exiting surface of the light guide plate, so as to uniformly illuminate the display panel. However, in the case where the backlight module illustrated in FIG. 1 is applied to a liquid crystal display device, it is found that luminance close to the light entering side of the light guide plate is high while luminance on the side of the light guide plate far away from the light entering side (i.e., the side far away from light source) is low, that is, there is a problem of non-uniform luminance. One of the causes of this problem is that commercially available light sources for illuminating the light guide plate generally have a large light-emitting angle, so that the edge portion 1 of the light beam entering the light guide plate from the light source has a small incident angle (less than the critical angle of total reflection) on the lower surface or the upper surface of the light guide plate, thus a lot of undesired light exits from the upper surface and/or the lower surface of the light guide plate by refraction near the light entering side of the light guide plate, and only a small portion of light may be transmitted to the side of the light guide plate far away from the light source by total reflection, resulting in a phenomenon that luminance is high near the light entering side and low on the side far away from the light source.

Disclosed is a backlight module that may comprise a light guide plate; a light source disposed adjacent to the light entering side of the light guide plate; and a light converging element disposed between the light guide plate and the light source, the light converging element being configured such that light, from the light source, incident on a surface of the light guide plate opposite to a light-exiting surface of the light guide plate may satisfy a total reflection condition at the surface.

In an embodiment of the present disclosure, the light-exiting surface of the light guide plate refers to a surface from which light in the light guide plate may exit for utilization by the display panel. In order to enable light to exit from the light-exiting surface of the light guide plate, it is usually possible to provide some light-exiting points on the light-exiting surface of the light guide plate, so that light transmitted in the light guide plate exits at the light-exiting points. In this embodiment, for the sake of convenience, the light-exiting surface of the light guide plate may be described as the upper surface of the light guide plate, and the surface opposite to the light-exiting surface may be described as the lower surface of the light guide plate.

In an embodiment of the present disclosure, the light converging element may appropriately converge light emitted by the light source, so as to decrease the divergence angle of the light beam, thereby increasing the incident angle of the light on the lower surface of the light guide plate. This makes it easier for light incident on the lower surface of the light guide plate to be totally reflected on the lower surface, whereby more light may be transmitted to the side of the light guide plate far away from the light source by total reflection, so that the uniformity of light exiting from the light-exiting points of the light guide plate may be improved.

It may be understood that as the light source emits a divergent light beam, a portion of light emitted from the light source to the light guide plate via the light converging element is also incident on the upper surface of the light guide plate. Light incident on the upper surface may also be totally reflected. However, for light incident on the light-exiting points on the upper surface, the total reflection thereof will be destroyed, such that light exits from the light guide plate.

FIG. 2 shows a schematic structural diagram of a backlight module in some embodiments of the present disclosure. As shown in FIG. 2, the backlight module may comprise a light guide plate 101, a light source 102 disposed adjacent to a light entering side of the light guide plate 101, and a light converging element 201 disposed between the light guide plate 101 and the light source 102. The light converging element 201 is configured such that light, from the light source 102, incident onto a surface (the lower surface shown in FIG. 2) of the light guide plate 101 opposite to a light-exiting surface (the upper surface shown in FIG. 2) of the light guide plate 101 may satisfy a total reflection condition at this surface.

As shown in FIG. 2, in the case where the light converging element 201 is not provided, light 1 travels along an optical path 2 and is incident on the lower surface of the light guide plate 101 at an incident angle φ; in the case where the light converging element 201 is provided, light 1 travels along an optical path 3 in the light guide plate and is incident onto the lower surface of the light guide plate 101 at an incident angle φ′. Obviously, the incident angle φ′ is larger than the incident angle φ. Therefore, in such configuration shown in FIG. 2, light having a larger divergence angle from the light source 102, after being converged by the light converging element, may be incident on the upper surface and/or the lower surface of the light guide plate at a larger incident angle φ′. Therefore, on the one hand, light entering the light guide plate may be more easily totally reflected in the light guide plate so as to be transmitted to the far light side by total reflection, and on the other hand, a portion of light incident on the light-exiting points of the light guide plate may exit from the light guide plate by refraction, whereby the uniformity of the outgoing light may be improved.

It may be understood that light, from the light source, transmitting to the lower surface of the light guide plate via the light converging element, after a total reflection on the lower surface, inevitably exists light rays that no longer satisfy the total reflection condition due to various factors, and these light rays may exit from the lower surface of the light guide plate and may not be used by the display device, resulting in waste of light energy. For example, as described above, the light-exiting points of the upper surface of the light guide plate may break the total reflection condition of the light incident thereon, with the result that the first portion of light may exit from the upper surface of the light guide plate by refraction, the second portion of light may continue to propagate in the light guide plate by total reflection, and the third portion of light may be incident on the lower surface of the light guide plate at an angle less than the critical angle of total reflection and thus may exit from the lower surface by refraction, which results in the waste of the third portion of light.

In an embodiment of the present disclosure, in order to reduce the waste caused by light exiting from the lower surface of the light guide plate, as shown in FIG. 2, a reflective element 202 may be provided on the lower surface of the light guide plate. In one or more embodiments, the reflective element 202 may be adhered to the light guide plate 101 through an adhesive layer 203.

In an configuration with the reflective element, as the refractive index of the adhesive layer is usually larger than the refractive index of air, the required critical angle at which total reflection of light occurs on the lower surface of the light guide plate is larger, and therefore light more easily exits from the lower surface of the light guide plate and is reflected in the vicinity of the light entering side by the reflective element toward the light-exiting surface of the light guide plate. In this case, the above-mentioned problem of non-uniformity of light exit from the light guide plate becomes more obvious. Therefore, in the embodiment having a configuration of a reflective element, it is highly advantageous to employ the light converging element to converge the divergent light beams emitted by the light source to increase the incident angle on the lower surface of the light guide plate.

In one or more embodiments, the light converging element and the light guide plate may be formed of the same material. In this configuration, the light converging element and the light guide plate may be integrally formed by molding, thereby greatly simplifying the process.

In one or more embodiments, the light converging element and the light guide plate may be made of a glass material. With this configuration, as the glass material has high intensity, the light guide plate made of such material may have a small thickness and does not require a special backplate for support, so the thickness of the backlight module may be reduced. It may be understood that, in an embodiment of the present disclosure, the light converging element and the light guide plate may also be formed of a resin material, for example, polymethyl methacrylate (PMMA), methylmethacrylate-styrene copolymer (MS), polycarbonate (PC) and so on. The light converging element and the light guide plate may also be formed of different materials, for example, the light converging element is made of a glass material and the light guide plate is made of a resin material. Other embodiments are possible.

In one or more embodiments, the light converging element may be a light converging prism, a light converging lens, or a combination thereof. In an embodiment, the light converging element may be a hemispherical convex lens. In another embodiment, the light converging element may be an isosceles triangular prism. It may be understood that the light converging element may also have other geometric shapes capable of converging light to increase the incident angle of light incident on the lower surface of the light guide plate.

In one or more embodiments, the light source may be an LED (a light-emitting diode) having a light-emitting angle from 110° to 120°.

In one or more embodiments, the light guide plate and the light converging element may have a refractive index from 1.45 to 1.60.

In one or more embodiments, the light converging element may be disposed on the surface of the light entering side of the light guide plate, and the light source may be disposed at a distance of 0.1 mm to 0.3 mm from the light converging element. It should be noted that the distance between the light source and the light converging element may be a distance between the light source and a point on the light converging element closest to the light source.

In one or more embodiments, the adhesive layer may have a refractive index greater than 1 and less than or equal to 1.35.

In one or more embodiments, the geometric parameters of the light converging element may be selected based on parameters such as the refractive index of the light guide plate, the refractive index of the light converging element, the refractive index of ambient gas (e.g., air), the refractive index of a medium (air or an adhesive layer) in contact with the lower surface of the light guide plate, as well as the light-emitting angle of the light source.

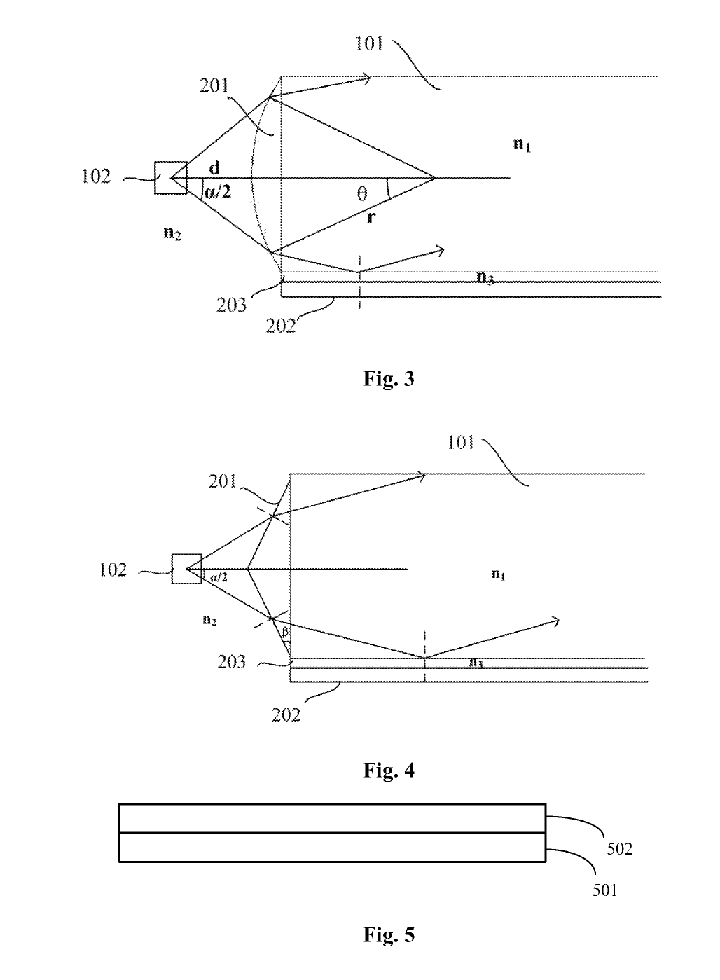

FIG. 3 shows a schematic representation of geometric parameters of various components of the backlight module in the case where the light converging element is a hemispherical convex lens. In the backlight module shown in FIG. 3, the light source 102 may be disposed on the symmetric axis of the hemispherical convex lens 201, and the hemispherical convex lens 201 and the light guide plate 101 may have the same refractive index (e.g., the both are made of a glass material). Equations (1) and (2) may be obtained based on geometric relationships among the components in FIG. 3 and refraction law, and a maximum radius of the hemispherical convex lens may be derived based on equations (1) and (2)

d+r·(1·cos θ)=r·sin θ/tan(α/2) (1)

n₂ sin(α/2+θ)=n₁ sin(90°·arcsin(n₃/n₁)+θ) (2)

Where, d is a distance between the light source and a point on the hemispherical convex lens closest to the light source;

θ is an angle between a normal of the hemispherical lens at an intersection of the outmost light ray of the light beam emitted by the light source and a hemispherical surface of the hemispherical lens and the symmetric axis of the hemispherical lens;

n₁ is the refractive index of the light guide plate and the hemispherical convex lens;

n₂ is the refractive index of ambient gas (air), the value of which is usually 1;

n₃ is the refractive index of a medium in contact with the side of the light guide plate (the lower surface of the light guide plate in FIG. 3) opposite to the light-exiting surface of the light guide plate;

α is the light-emitting angle of the light source.

In this embodiment, the hemispherical convex lens having a radius not larger than that calculated according to the above equations (1) and (2) may increase the incident angle of light incident on the lower surface of the light guide plate, so that light satisfies the total reflection conditions on the lower surface of the light guide plate.

As an example, in the case where the medium in contact with the lower surface of the light guide plate is an adhesive layer for bonding the reflective element, assuming that the light-emitting angle α of the light source is 120°; the distance d between the light source and the point on the hemispherical convex lens closest to the light source is 0.2 mm; the refractive index n₃ of the adhesive layer is 1.35; the refractive index n₁ of the light guide plate and the hemispherical convex lens is 1.5; and the refractive index n₂ of ambient gas is 1, then according to the equations (1) and (2), the minimum radius of the hemispherical convex lens r may be calculated and is equal to 1.81 mm.

It may be understood that the above equations (1) and (2) are obtained under the condition that the light guide plate and the hemispherical convex lens have the same refractive index, and in the case where they have different refractive indexes, the minimum radius of the hemispherical convex lens may likewise be calculated based on the geometric relationship and the refraction law.

FIG. 4 shows a schematic representation of geometric parameters of various components of the backlight module in the case where the light converging element is an isosceles triangular prism. For the backlight module shown in FIG. 4, the light source 102 may be disposed on the symmetric axis of the isosceles triangular prism 201, and the isosceles triangular prism 201 and the light guide plate 101 may have the same refractive index (e.g., the both are made of a glass material). Based on the geometric relationship shown in FIG. 4 and the refraction law, the minimum base angle β of the isosceles triangular prism may be derived by the following equation:

n₂ sin(α/2+β)=n₁ sin(90°·arcsin(n₃/n₁)+β) (3)

Where, n₁ is the refractive index of the light guide plate and the isosceles triangular prism;

n₂ is the refractive index of ambient gas;

n₃ is the refractive index of the medium in contact with the side of the light guide plate (the lower surface of the light guide plate in FIG. 4) opposite to the light-exiting surface of the light guide plate.

α is the light-emitting angle of the light source.

In this embodiment, an isosceles triangular prism having a base angle not greater than that calculated according to the above equation (3) may increase the incident angle of light incident on the lower surface of the light guide plate, so that light satisfies the total reflection conditions on the lower surface of the light guide plate.

In one or more embodiments, in order to make full use of light emitted by the light source and improve the utilization of light energy, the light source and the light converging element may be selected based on the thickness of the light guide plate, wherein the light source may be selected such that the light spot of the light beam emitted by the light source on a plane where the light entering surface of the light guide plate is located is not larger than a size of the light guide plate in the thickness direction; a size of the light converging element in the thickness direction of the light guide plate may be set to be no less than the size of the light spot of the light beam emitted by the light source on the entering surface of the light guide plate in the thickness direction of the light guide plate. That is, the size of the light converging element in the thickness direction of the light guide plate may be configured such that all the light emitted by the light source may be incident on the light converging element and be transmitted through the light converging element to enter the light guide plate.

The content disclosed herein also relates to a display device. The display device may comprise a backlight module according to the disclosure, such as the backlight module according to one or more of the embodiments disclosed in detail hereinabove. For optional embodiments of the display device, reference may be made to the description about various embodiments of the backlight module.

FIG. 5 shows a schematic structural diagram of a display device in an embodiment of the present disclosure. As shown in FIG. 5, the display device in an embodiment of the present disclosure may include a backlight module 501 in any of the embodiments shown in FIG. 2 to FIG. 3 and a display panel 502.

The foregoing description of the embodiment has been provided for purpose of illustration and description. It is not intended to be exhaustive or to limit the application. Individual elements or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the application, and all such modifications are included within the scope of the application.

1. A backlight module, comprising:
a light guide plate;
a light source disposed adjacent to a light entering side of the light guide plate; and
a light converging element disposed between the light guide plate and the light source, the light converging element being configured such that light, from the light source, incident on a surface of the light guide plate opposite to a light-exiting surface of the light guide plate satisfies a total reflection condition at the surface.

2. The backlight module according to claim 1, wherein the light converging element is disposed on a surface of the light entering side of the light guide plate.

3. The backlight module according to claim 2, wherein the light converging element and the light guide plate are formed of the same material.

4. The backlight module according to claim 3, wherein the light converging element and the light guide plate comprise a glass material or a resin material.

5. The backlight module according to claim 1, wherein the light converging element comprises a light converging prism, a light converging lens, or a combination thereof.

6. The backlight module according to claim 5, wherein the light converging element comprises a hemispherical convex lens.

7. The backlight module according to claim 6, wherein a maximum radius r of the hemispherical convex lens is calculated according to the following equation:
d+r·(1−cos θ)=r·sin θ/tan(α/2)
Where, the light source is disposed on a symmetric axis of the hemispherical convex lens, and the hemispherical convex lens and the light guide plate have the same refractive index;
d is a distance between the light source and a point on the hemispherical convex lens closest to the light source;
θ is an angle between a normal of the hemispherical convex lens at an intersection of an edge light ray of the light emitted by the light source and a hemispherical surface of the hemispherical convex lens and the symmetric axis, and is calculated by the following equation:
n₂ sin(α/2+θ)=n₁ sin(90°·arcsin(n₃/n₁)+θ);
Where, n₁ is the refractive index of the light guide plate and the hemispherical convex lens;
n₂ is a refractive index of ambient gas;
n₃ is a refractive index of a medium in contact with a side of the light guide plate opposite to the light-exiting surface of the light guide plate;
α is a light-emitting angle of the light source.

8. The backlight module according to claim 5, wherein the light converging element comprises an isosceles triangular prism.

9. The backlight module according to claim 8, wherein the isosceles triangular prism has a minimum base angle β calculated according to the following equation:
n₂ sin(α/2+β)=n₁ sin(90°·arcsin(n₃/n₁)+β)
Where, the light source is disposed on a symmetric axis of the isosceles triangular prism, and the isosceles triangular prism and the light guide plate have the same refractive index;
n₁ is the refractive index of the light guide plate and the isosceles triangular prism;
n₂ is a refractive index of ambient gas;
n₃ is a refractive index of a medium in contact with a side of the light guide plate opposite to the light-exiting surface of the light guide plate;
α is a light-emitting angle of the light source.

10. The backlight module according to claim 6, wherein the light source comprises an LED having a light-emitting angle ranging from 110° to 120°.

11. The backlight module according to claim 6, wherein the refractive index of the light guide plate and the light converging element ranges from 1.45 to 1.60.

12. The backlight module according to claim 6, wherein the distance between the light source and the light converging element ranges from 0.1 mm to 0.3 mm.

13. The backlight module according to claim 1, further comprising a reflective element disposed on a surface of the light guide plate opposite to the light-exiting surface of the light guide plate and an adhesive layer configured for adhering the reflective element to the light guide plate.

14. The backlight module according to claim 13, wherein the refractive index of the adhesive layer has a range of larger than 1 and less than or equal to 1.35.

15. A display device comprising a display panel and a backlight module according to claim 1.

16. The display device according to claim 15, wherein the light converging element is disposed on a surface of the light entering side of the light guide plate.

17. The display device according to claim 15, wherein the light converging element comprises a hemispherical convex lens.

18. The display device according to claim 17, wherein a maximum radius r of the hemispherical convex lens is calculated according to the following equation:
d+r·(1−cos θ)=r·sin θ/tan(α/2)
Where, the light source is disposed on a symmetric axis of the hemispherical convex lens, and the hemispherical convex lens and the light guide plate have the same refractive index;
d is a distance between the light source and a point on the hemispherical convex lens closest to the light source;
θ is an angle between a normal of the hemispherical convex lens at an intersection of an edge light ray of the light emitted by the light source and a hemispherical surface of the hemispherical convex lens and the symmetric axis, and is calculated by the following equation:
n₂ sin(α/2+θ)=n₁ sin(90°·arcsin(n₃/n₁)+θ);
Where, n₁ is the refractive index of the light guide plate and the hemispherical convex lens;
n₂ is a refractive index of ambient gas;
n₃ is a refractive index of a medium in contact with a side of the light guide plate opposite to the light-exiting surface of the light guide plate;
α is a light-emitting angle of the light source.

19. The display device according to claim 15, wherein the light converging element comprises an isosceles triangular prism.

20. The display device according to claim 19, wherein the isosceles triangular prism has a minimum base angle β calculated according to the following equation:
n₂ sin(α/2+β)=n₁ sin(90°·arcsin(n₃/n₁)+β)
Where, the light source is disposed on a symmetric axis of the isosceles triangular prism, and the isosceles triangular prism and the light guide plate have the same refractive index;
n₁ is the refractive index of the light guide plate and the isosceles triangular prism;
n₂ is a refractive index of ambient gas;
n₃ is a refractive index of a medium in contact with a side of the light guide plate opposite to the light-exiting surface of the light guide plate;
α is a light-emitting angle of the light source.
